(19) United States
(12) Patent Application Publication
(10) Pub. No.: US 2020/0304693 A1
(43) Pub. Date: Sep. 24, 2020

(54) CAMERA MODULE AND ELECTRONIC DEVICE USING SAME

(71) Applicant: TRIPLE WIN TECHNOLOGY(SHENZHEN) CO.LTD., Shenzhen (CN)

(72) Inventors: XIAO-MEI MA, Shenzhen (CN); SHIN-WEN CHEN, Tu-Cheng (TW); LONG-FEI ZHANG, Shenzhen (CN); KUN LI, Shenzhen (CN)

(21) Appl. No.: 16/438,645

(22) Filed: Jun. 12, 2019

(30) Foreign Application Priority Data
Mar. 18, 2019 (CN) 201910204841.7

(51) Int. Cl. H04N 5/225

(52) U.S. Cl. CPC H04N 5/2254; H04N 5/22521

(57) ABSTRACT

A lens module of reduced dimensions includes a circuit board, a photosensitive chip, at least one electronic component, a first plastic layer, and a second plastic layer. The photosensitive chip is located on a surface of the circuit board and covered by the first plastic layer but the electronic component is located on an opposite surface and covered by the second plastic layer. Such arrangement avoids lateral gaps between the electronic components and the photosensitive chip and the metal wires. An electronic device including such a lens module is also provided.

### FIELD

The subject matter herein generally relates to image-capturing devices.

### BACKGROUND

A lens module may include lenses, a lens holder, a carrier, a filter, a photosensitive chip, and a circuit board. The lens modules are required to be reduced in size because the electronic devices that applying the lens modules are becoming thinner. Although the lens modules fabricated under the traditional COB (Chip On Board) packaging process are stable, the lens modules are large, and miniaturization is problematic.

Thus, there is room for improvement within the art.

### BRIEF DESCRIPTION OF THE DRAWINGS

Implementations of the present technology will now be described, by way of embodiments, with reference to the attached figures.

FIG. 1 is an isometric view of a lens module according to an embodiment of the present disclosure.

FIG. 2 is an exploded view of the lens module of FIG. 1.

FIG. 3 is an exploded view of the lens module of FIG. 1 from another angle.

FIG. 4 is a cross-sectional view along line IV-IV of FIG. 1.

FIG. 5 is a perspective view of an electronic device using a lens module according to an embodiment of the present disclosure.

### DETAILED DESCRIPTION

The present disclosure is made in conjunction with the accompanying drawings. Specific embodiments of the present disclosure are described.

In the following description, when an element is described as being “fixed to” another element, the element can be fixed to the another element with or without intermediate elements. When an element is described as “connecting” or “connecting to” another element, the element can be connected to the other element with or without intermediate elements.

Without a definition otherwise, all terms given below are of the same meaning as commonly understood by those skilled in the art. The term “and/or” means including any and all combinations of one or more of associated listed items.

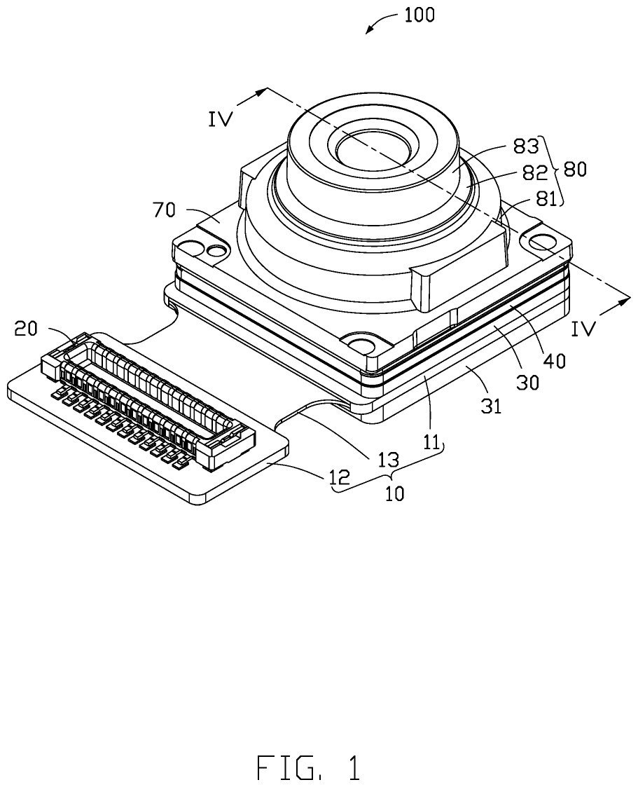

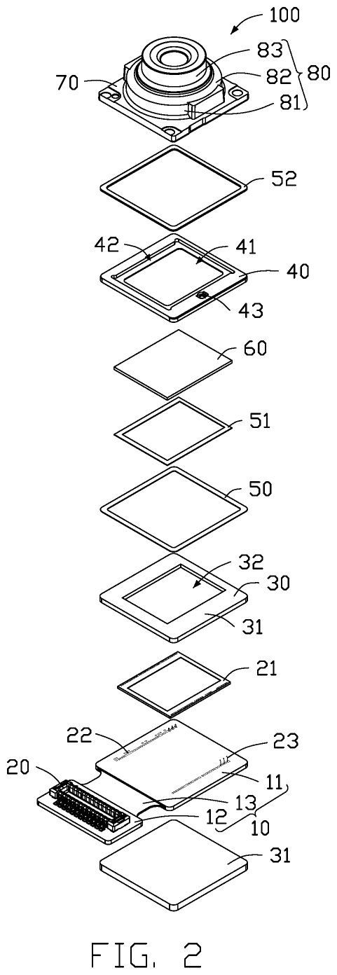

Referring to FIG. 1 and FIG. 2, an embodiment of the present disclosure provides a lens module 100. The lens module 100 includes a circuit board 10, a carrier 40, a filter 60, and a lens holder 70, and a lens unit 80.

The circuit board 10 can be a ceramic substrate, a soft board, a hard board, or a board combining soft and hard. In the embodiment, the circuit board 10 is a soft and hard board, and includes a first hard board portion 11, a second hard board portion 12, and a soft board portion 13 connected between portions 11 and 12. An electrical connection element 20 is mounted on the second hard board portion 12. When the lens module 100 is installed in an electronic device (not shown), the electrical connection element 20 transmits signals between the lens module 100 and other components of the electronic device. In the embodiment, the electrical connection element 20 can be an edge connector or a gold finger.

One surface of the first hard board portion 11 carries a photosensitive chip 21 and a plurality of metal wires 23. The photosensitive chip 21, the metal wires 23 and the electrical connection element 20 are located on a same side of the circuit board 10. The photosensitive chip 21 is electrically connected to the first hard board portion 11 through the metal wires 23. In the embodiment, the photosensitive chip 21 is rectangular in shape. An opposite surface of the first hard board portion 11 carries at least one electronic component 22 electrically connected to the first hard board portion 11. The electronic component 22 can be a passive component such as a resistor, a capacitor, a diode, a transistor, a relay, or an electrically erasable programmable read only memory (EEPROM).

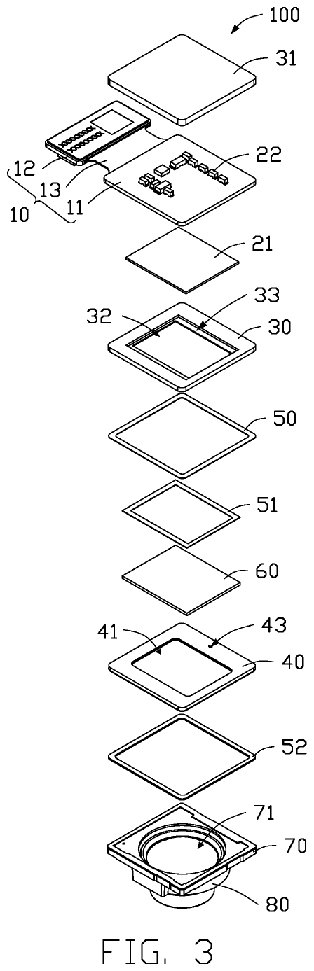

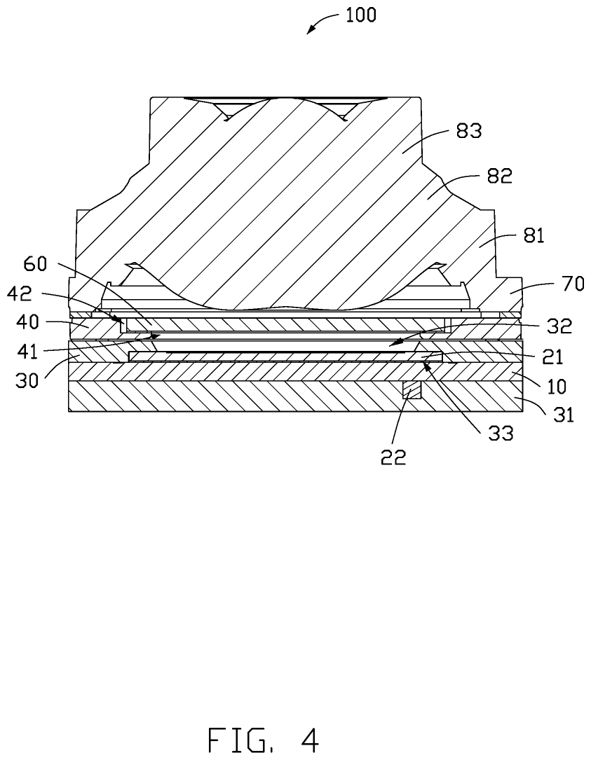

Referring to FIG. 3 and FIG. 4, in the embodiment, the lens module 100 further includes a first plastic layer 30 and a second plastic layer 31. The first plastic layer 30 is located on the surface of the first hard board portion 11 where the photosensitive chip 21 is located. In the embodiment, the first plastic layer 30 is substantially a hollow rectangular structure and includes a main body 31 and a first through hole 32 defined on the main body 31. The photosensitive chip 21 has a photosensitive area and a non-photosensitive area not sensitive to light surrounding the photosensitive area. The metal wires 23 electrically connect the non-photosensitive area of the photosensitive chip 21 with the first hard board portion 11. The first through hole 32 of the first plastic layer 30 is aligned with the photosensitive area of the photosensitive chip 21 and exposes the photosensitive area of the photosensitive chip 21. The main body 31 of the first plastic layer 30 covers and encloses the non-photosensitive region of the photosensitive chip 21 and the metal wires 23. In the embodiment, the first plastic layer 30 further includes a first recess 33 recessed toward the circuit board 10 and surrounding the first through hole 32. The photosensitive chip 21 is received in the first recess 33.

The second plastic layer 31 is located on the surface of the first hard board portion 11 where the electronic component 22 is located. In the embodiment, the second plastic layer 31 is substantially rectangular in shape. The second plastic layer 31 defines a groove (not shown) for receiving and covering the electronic component 22, the electronic component 22 is thereby packaged on the first hard board portion 11. In the embodiment, the first plastic layer 30 and the second plastic layer 31 are both injection molded elements.

In a conventional lens module, for the electronic component, the photosensitive chip and the metal wires are located on a same surface of a circuit board, and lateral gaps exist between the photosensitive chip and the metal wires. In the embodiment, lateral gaps are avoided and a lateral dimension of the lens module 100 is reduced where the electronic component 22 is located on a surface of the circuit board 10 and the photosensitive chip 21 is located on opposite surface of the circuit board 10. Thus, the lens module 100 is miniaturized. Furthermore, the first plastic layer 30 and the second plastic layer 31 effectively prevent external contaminants reaching the photosensitive chip 21 and the electronic component 22, thereby improving the imaging quality of the lens module 100. The first plastic layer 30 covers the metal wires 23 and prevents reflections therefrom and flashing and ghost imaging on the photosensitive chip 20 are reduced. The second plastic layer 31 effectively shields against light leaking from the circuit board 10, and improves the imaging quality of the lens module 100 further. The electronic component 22 is disposed on a surface of the circuit board 10 away from the photosensitive chip 21, preventing reflections of light from the electronic component 22 and reducing flashing and ghost imaging on the photosensitive chip 20, thereby improving the imaging quality of the lens module 100.

In the embodiment, the carrier 40 is mounted on the first plastic layer 30 through a first adhesive layer 50. The carrier 40 is substantially a hollow rectangular structure and defines a second through hole 41. The second through hole 41 is aligned with the photosensitive area of the photosensitive chip 21 and exposes the photosensitive area of the photosensitive chip 21. The carrier 40 defines a second recess 42 and an air venting hole 43. The second recess 42 recesses inwardly from a surface of the carrier 40 away from the circuit board 10 and surrounds the second through hole 41. The air venting hole 43 runs through the carrier 40 and has a central axis substantially parallel to a central axis of the second through hole 41. The carrier 40 can be made of metal or plastic. In this embodiment, the carrier 40 is made of plastic.

The filter 60 is mounted in the second recess 42 of the carrier 40 through a second adhesive layer 51. In the present embodiment, the filter 60 has a rectangular shape.

The lens holder 70 is mounted on the surface of the carrier 40 away from the circuit board 10 through a third adhesive layer 52. The lens holder 70 is substantially a rectangular parallelepiped structure. A receiving hole 71 is defined in the lens holder 70. The lens holder 70 is made of metal or plastic. In this embodiment, the lens holder 70 is made of an aluminum alloy.

The lens unit 80 is received in the receiving hole 71 of the lens holder 70. The lens unit 80 and the lens holder 70 are assembled together or integrally formed. In the embodiment, the lens unit 80 and the lens holder 70 are integrally formed by an injection molding process. The lens unit 80 includes a first lens 81, a second lens 82, and a third lens 83. The second lens 82 is located between the first lens 81 and the third lens 83. The first lens 81, the second lens 82, and the third lens 83 are sequentially decreased in diameter. The lens unit 80 is integrally formed or can be assembled by assembling the first lens 81, the second lens 82, and the third lens 83 together. In the embodiment, the first lens 81, the second lens 82, and the third lens 83 are integrally formed to form the lens unit 80.

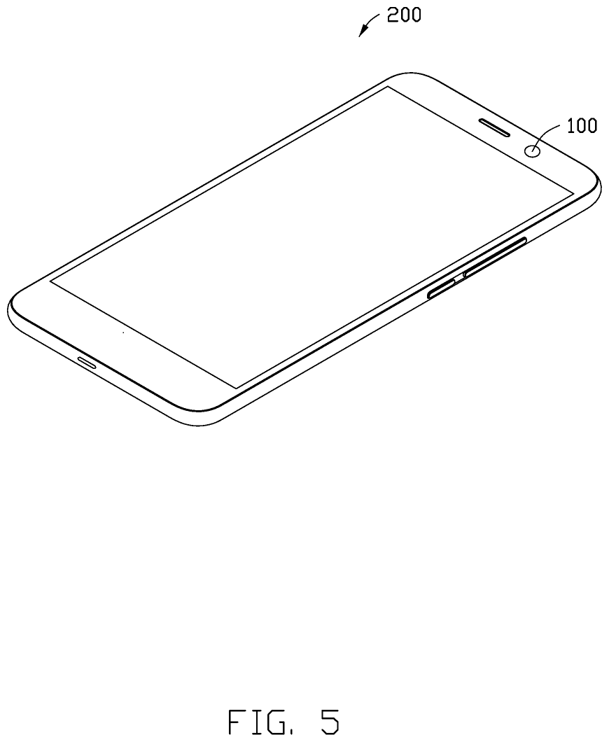

Referring to FIG. 5, the lens module 100 can be applied to various electronic devices equipped with camera modules, such as mobile phones, wearable devices, computer devices, vehicles, or monitoring devices. In the embodiment, the lens module 100 is applied to a mobile phone 200.

The lens module 100 provided by the present disclosure has the following beneficial effects. The electronic component 22 is located on a surface of the circuit board 10 which is not the surface on which the photosensitive chip 21 and the metal wire 23 are located, thereby avoiding lateral gaps between the electronic component 22 and the photosensitive chip 21 and the metal wire 23, and thereby reducing a lateral dimension of the lens module 100, and achieving better miniaturization of the lens module 100. The embodiments shown and described above are only examples. Even though numerous characteristics and advantages of the present technology have been set forth in the foregoing description, together with details of the structure and function of the present disclosure, the disclosure is illustrative only, and changes can be made in the detail, including in matters of shape, size, and arrangement of the parts within the principles of the present disclosure, up to and including the full extent established by the broad general meaning of the terms used in the claims.

What is claimed is:

1. A lens module comprising a circuit board, a photosensitive chip, at least one electronic component, a first plastic layer and a second plastic layer, wherein the photosensitive chip is located on a surface of the circuit board and covered by the first plastic layer, and the electronic component is located on another opposite surface of the circuit board and covered by the second plastic layer.

2. The lens module as claimed in claim 1, further comprising at least one metal wire, wherein the metal wire electrically connects the photosensitive chip to the circuit board, and is covered by the first plastic layer.

3. The lens module as claimed in claim 2, wherein the first plastic layer comprising a main body and a first through hole defined on the main body, the photosensitive chip has a photosensitive area and a non-photosensitive area surrounding the photosensitive area, the first through hole is aligned with the photosensitive area of the photosensitive chip and exposes the photosensitive area, the main body covers the non-photosensitive area of the photosensitive chip and the metal wire.

4. The lens module as claimed in claim 3, wherein the first plastic layer further comprising a first recess recessed toward the circuit board and surrounding the first through hole, the photosensitive chip is received in the first recess.

5. The lens module as claimed in claim 3, wherein the lens module further comprises a carrier, the carrier is located on the first plastic layer, the carrier defines a second through hole, the second through hole is aligned with the photosensitive area of the photosensitive chip and exposes the photosensitive area of the photosensitive chip.

6. The lens module as claimed in claim 5, wherein the carrier defines an air venting hole running through the carrier.

7. The lens module as claimed in claim 5, wherein the carrier defines a second recess recessed inwardly from a surface of the carrier away from the circuit board and surrounding the second through hole, the lens module further comprises a filter mounted in the second recess.

8. The lens module as claimed in claim 5, wherein the lens module further comprises a lens holder and a lens unit, the lens holder is mounted on the carrier away from the circuit board and defines a receiving hole for receiving the lens unit.

9. The lens module as claimed in claim 7, wherein the lens unit is integrally formed with the lens holder, and the lens unit comprises a first lens, a second lens and a third lens, the second lens is coupled between the first lens and the third lens, the first lens, the second lens, and the third lens are sequentially decreased in diameter.

10. The lens module as claimed in claim 1, wherein the second plastic layer defines a groove for receiving and covering the electronic component.

11. An electronic device comprising a lens module, the lens module comprising a circuit board, a photosensitive chip, at least one electronic component, a first plastic layer and a second plastic layer, wherein the photosensitive chip is located on a surface of the circuit board and covered by the first plastic layer, and the electronic component is located on another opposite surface of the circuit board and covered by the second plastic layer.

12. The electronic device as claimed in claim 11, wherein the lens module further comprises at least one electrically connecting t photosensitive chip to the circuit board and covered by the first plastic layer.

13. The electronic device as claimed in claim 12, wherein the first plastic layer comprising a main body and a first through hole defined on the main body, the photosensitive chip has a photosensitive area and a non-photosensitive area surrounding the photosensitive area, the first through hole is aligned with the photosensitive area of the photosensitive chip and exposes the photosensitive area, the main body covers the non-photosensitive area of the photosensitive chip and the metal wire.

14. The electronic device as claimed in claim 13, wherein the first plastic layer further comprising a first recess recessed toward the circuit board and surrounding the first through hole, the photosensitive chip is received in the first recess.

15. The electronic device as claimed in claim 13, wherein the lens module further comprises a carrier, the carrier is located on the first plastic layer, the carrier defines a second through hole, the second through hole is aligned with the photosensitive area of the photosensitive chip and exposes the photosensitive area of the photosensitive chip.

16. The electronic device as claimed in claim 15, wherein the carrier defines an air venting hole running through the carrier.

17. The electronic device as claimed in claim 15, wherein the carrier defines a second recess recessed inwardly from a surface of the carrier away from the circuit board and surrounding the second through hole, the lens module further comprises a filter mounted in the second recess.

18. The electronic device as chimed in claim 15, wherein the lens module further comprises a lens holder and a lens unit, the lens holder is mounted on the carrier away from the circuit board and defines a receiving hole for receiving the lens unit.

19. The electronic device as claimed in claim 17, wherein the lens unit is integrally formed with the lens holder, and the lens unit comprises a first lens, a second lens and a third lens, the second lens is coupled between the first lens and the third lens, the first lens, the second lens, and the third lens are sequentially decreased in diameter.

20. The electronic device as claimed in claim 11, wherein the second plastic layer defines a groove for receiving and covering the electronic component.
